(19) United States
(12) Patent Application Publication
(10) Pub. No.: US 2026/0197371 A1
(43) Pub. Date: Jul. 9, 2026

(54) SETTING OF PARTITIONED AND UNPARTITIONED COOKIES FOR CROSS-DOMAIN FUNCTIONALITY

(71) Applicant: SAP SE, Walldorf (DE)

(72) Inventors: Vipul Khullar, Gurugram (IN); Achim Braemer, Heidelberg (DE); Niklas Albers, Heidelberg (DE); Wolfgang Janzen, Mannheim (DE)

(73) Assignee: SAP SE, Walldorf (DE)

(21) Appl. No.: 19/015,494

(22) Filed: Jan. 9, 2025

(51) Int. Cl. H04L 67/141; H04L 67/146; H04L 67/306

(52) U.S. Cl. CPC H04L 67/141; H04L 67/146; H04L 67/306

(57) ABSTRACT

The present disclosure provides techniques for managing cookies in interactions involving multiple network domains. Upon receiving a request to set cookies for a second network domain while processing a web page of a first network domain, both partitioned and unpartitioned cookies are issued and stored. Having both types of cookies available allows for seamless operation regardless of the browser, first-party domain, or third-party domain support for different cookie handling mechanisms, including when traditional third-party cookies are not available. Policies can be set to determine when both cookie types should be set, or when only one type of cookie is needed. If a third-party domain does not support the issuance of both types of cookies, a web proxy can be used to perform the relevant operations.

### FIELD

The present disclosure generally relates to web browser interactions with third-party domains.

### BACKGROUND

Cookies are small text files that are stored on a user’s device by a web browser at the request of a website. They serve various purposes, such as maintaining session information, storing user preferences, and enabling website functionality. Cookies are categorized into first-party and third-party cookies, based on their origin. First-party cookies are created and accessed directly by the website a user visits, while third-party cookies are created by domains other than the one the user is directly interacting with. Third-party cookies are often used by advertisers and analytics providers to track user behavior across multiple websites.

The use of third-party cookies has generated significant privacy concerns due to their role in facilitating cross-site tracking and behavioral profiling. By enabling the collection of user data across different websites, third-party cookies allow advertisers to build detailed profiles of individual users. This practice has been criticized for its potential to infringe on user privacy and for enabling intrusive advertising practices. In response to these concerns, several major web browsers have taken steps to block or phase out third-party cookies, reflecting a broader industry shift toward more privacy-focused technologies.

Despite these privacy concerns, third-party cookies have legitimate uses that extend beyond targeted advertising. They are often employed to provide functionalities such as fraud detection, identity verification, and the enablement of single sign-on (SSO) systems that allow users to access multiple services with a single set of credentials. These cookies also facilitate interoperability between websites and third-party service providers, needed for delivering a seamless user experience. The deprecation of third-party cookies threatens to disrupt these legitimate use cases, creating technical and operational challenges for service providers and website operators.

As the industry transitions away from third-party cookies, various alternative technologies and approaches have been proposed to balance privacy with functionality. However, these alternatives are not without their own challenges. Some may introduce complexity in implementation or fail to achieve the same level of interoperability, while others may present their own privacy risks. Accordingly, room for improvement exists.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The present disclosure provides techniques for managing cookies in interactions involving multiple network domains. Upon receiving a request to set cookies for a second network domain while processing a web page of a first network domain, both partitioned and unpartitioned cookies are issued and stored. Having both types of cookies available allows for seamless operation regardless of the browser, first-party domain, or third-party domain support for different cookie handling mechanisms, including when traditional third-party cookies are not available. Policies can be set to determine when both cookie types should be set, or when only one type of cookie is needed. If a third-party domain does not support the issuance of both types of cookies, a web proxy can be used to perform the relevant operations.

In one aspect, the present disclosure provides a process of managing cookies in a computing system that includes a web browser. In association with a web page of a first network domain, a first request to set a cookie for a second network domain is received. In response to receiving the first request, a partitioned cookie for the second network domain scoped for access by the first network domain and an unpartitioned cookie for the second network domain are received. The partitioned cookie and the unpartitioned cookie are stored by a web browser. For operations processing the web page, a second request for resources of the second network domain is received by the web browser. The web browser selectively uses either the partitioned cookie or the unpartitioned cookie to retrieve data from the second network domain for use in processing the web page.

In another aspect, the present disclosure provides a process of issuing and sending cookies to a web browser of a first network domain. In association with a web page of a first network domain, a first request to set a cookie for a second network domain is received. In response to receiving the first request, a partitioned cookie for the second network domain scoped for access by the first network domain and an unpartitioned cookie for the second network domain are issued. The partitioned cookie and the unpartitioned cookie are sent to the first network domain.

In a further aspect, the present disclosure provides a process of handling cookies in a computing system that mediates communications between a first network domain and a second network domain. A partitioned cookie scoped for a second network domain or an unpartitioned cookie for the first network domain is received from a first network domain. When the partitioned cookie is received, the partitioned cookie and a generated unpartitioned cookie for the first network domain are sent to the second network domain. When the unpartitioned cookie is received, the unpartitioned cookie and a generated partitioned cookie, scoped for the second network domain, are sent to the second network domain.

The present disclosure also includes computing systems and tangible, non-transitory computer readable storage media configured to carry out, or including instructions for carrying out, an above-described method. As described herein, a variety of other features and advantages can be incorporated into the technologies as desired.

### BRIEF DESCRIPTION OF THE DRAWINGS

FIG. 1 is a diagram illustrating how access to content of third-party domains can be provided using a cookie and an iframe.

FIG. 2 is a diagram illustrating how access to content of third-party domains can be provided using a storage access API.

FIG. 3 illustrates how third-party content can be retrieved when both partitioned and unpartitioned cookies for a third-party domain are maintained in association with a first-party domain.

FIG. 4 illustrates how third-party content can be retrieved using a storage access API when both partitioned and unpartitioned cookies for a third-party domain are maintained in association with a first-party domain.

FIG. 5 illustrates how use of both partitioned and unpartitioned cookies for a third-party domain can be affected by permissions settings for the third-party domain.

FIG. 6 is a table illustrating various type of cookie issuance policies.

FIG. 7 illustrates a computing environment where a web proxy adds a second cookie type to a first cookie type generated by a third-party domain, and sends both cookies to a web browser.

FIG. 8 presents example code for setting both partitioned and unpartitioned cookies.

FIG. 9A is a flowchart of process of managing cookies in a computing system that includes a web browser.

FIG. 9B is a flowchart of process of issuing and sending cookies to a web browser of a first network domain.

FIG. 9C is a flowchart of process of handling cookies in a computing system that mediates communications between a first network domain and a second network domain.

FIG. 10 is a diagram of an example computing system in which some described embodiments can be implemented.

FIG. 11 is an example cloud computing environment that can be used in conjunction with the technologies described herein.

### DETAILED DESCRIPTION

### Example 1– Overview

Cookies are small text files that are stored on a user’s device by a web browser at the request of a website. They serve various purposes, such as maintaining session information, storing user preferences, and enabling website functionality. Cookies are categorized into first-party and third-party cookies based on their origin. First-party cookies are created and accessed directly by the website a user visits, while third-party cookies are created by domains other than the one the user is directly interacting with.

As used herein, “domain” is shorthand for “network domain,” where a network domain is a logical namespace within a networked system that identifies and organizes resources, services, and entities under a common addressing scheme. A network domain may correspond to an Internet domain, as defined by the Domain Name System (DNS), or a private intranet domain used within a localized network.

A network domain is characterized by a distinct administrative boundary and naming convention that allows for unique identification and access to resources. For example, a network domain may be associated with a public DNS entry such as “example.com” or with a private subdomain such as “intranet.local” used within an enterprise network. The term “network domain” is not limited to any specific technology or protocol and is intended to encompass both hierarchical domain names used in DNS and alternative naming systems employed in private or proprietary networks.

As used herein, “first-party domain” refers to a network domain that directly corresponds to the primary context in which a user interacts with a website, application, or digital service. The first-party domain is the domain associated with the resource explicitly accessed by the user, as indicated in the browser's address bar or the application’s primary endpoint. For example, if a user navigates to “example.com,” the first-party domain for that session is “example.com.” Resources, cookies, and other data associated with this domain are considered part of the first-party context.

As used herein, “third-party domain” refers to a network domain distinct from the first-party domain in which additional resources, services, or content are hosted or accessed during a user’s interaction with a first-party site or application. A third-party domain is generally associated with external entities or services that are integrated into the first-party experience, such as analytics providers, advertisement networks, or embedded resources. For example, if a user visits “example.com” (the first-party domain) and the website loads content from “cdn.example-assets.com” or “analytics-provider.com,” those domains are considered third-party domains relative to the first-party domain.

The use of third-party cookies has generated significant privacy concerns due to their role in facilitating cross-site tracking and behavioral profiling. By enabling the collection of user data across different websites, third-party cookies allow advertisers to build detailed profiles of individual users. This practice has been criticized for its potential to infringe on user privacy and for enabling intrusive advertising practices. In response to these concerns, several major web browsers have taken steps to block or phase out third-party cookies, reflecting a broader industry shift toward more privacy-focused technologies.

Despite these privacy concerns, third-party cookies have legitimate uses that extend beyond targeted advertising. They are often employed to provide functionalities such as fraud detection, identity verification, and the enablement of single sign-on (SSO) systems that allow users to access multiple services with a single set of credentials. These cookies also facilitate interoperability between websites and third-party service providers, needed for delivering a seamless user experience. The deprecation of third-party cookies threatens to disrupt these legitimate use cases, creating technical and operational challenges for service providers and website operators.

As the industry transitions away from third-party cookies, various alternative technologies and approaches have been proposed to balance privacy with functionality. However, these alternatives are not without their own challenges. Some may introduce complexity in implementation or fail to achieve the same level of interoperability, while others may present their own privacy risks. Accordingly, room for improvement exists.

Third-party cookies enable a variety of legitimate use cases that support cross-site functionality and interoperability. For example, in the cross-site loading of protected media, such as images or videos hosted on a third-party domain like SAP MEDIA SHARE of SAP SE, Walldorf, Germany, third-party cookies are often employed as part of the authentication process. These cookies allow the third-party service to verify user permissions and grant authorized access to protected resources. Without these cookies, users may encounter errors when attempting to load media assets, resulting in incomplete page rendering or degraded user experiences. For instance, when a video stored in a protected repository fails to load due to missing authentication cookies, important application functionality may break.

Cross-site CSS loading is another common scenario that benefits from third-party cookies. Style sheets retrieved from protected third-party repositories are often used for maintaining consistent theming and layout across applications. These requests typically rely on single sign-on (SSO) cookies for authentication, enabling seamless cross-application integration. Without third-party cookies, the browser cannot authenticate these requests, leading to visual inconsistencies or missing styles in the user interface. For example, integrations with the UI Theming Service often depend on third-party cookies to enforce consistent branding and layout across enterprise systems, ensuring a cohesive user experience throughout an organization’s digital properties.

Cross-site fetch requests introduce additional challenges. These requests, typically initiated by JavaScript, allow first-party websites to retrieve data from third-party systems dynamically. Such requests are used in areas such as real-time analytics or dashboard integrations. For instance, SAP ANALYTICS CLOUD (SAC, also of SAP, SE) frequently relies on fetch requests authenticated by third-party cookies to access sensitive data. When third-party cookies are unavailable, these requests may fail, resulting in missing data or broken functionality. A specific challenge arises when these fetch requests are embedded in workflows requiring synchronization, such as generating real-time reports, where even partial failures can disrupt the broader process.

Iframes add another dimension of complexity. The <iframe> element is a fundamental tool in web development, allowing content, applications, or services hosted on one domain to be embedded within a parent webpage hosted on another domain. This structure is especially valuable in enterprise environments, where systems from various domains must interoperate seamlessly. For example, a centralized corporate dashboard might embed analytics tools, collaboration platforms, and reporting applications—each hosted on distinct domains—into a single unified portal. The iframe provides the structural framework to contain the embedded content while maintaining the autonomy of the originating domain.

Embedding via iframes is particularly important in scenarios where systems hosted on separate domains need to integrate without duplicating or transferring content. By embedding tools like analytics dashboards or collaboration platforms within iframes, enterprises can centralize functionality while maintaining security and operational independence for each system. This method is also widely employed for embedding multimedia content, advertisements, and maps into websites, enabling external resources to operate independently within a parent application.

However, iframe-based integrations often rely on third-party cookies for functionalities like authentication, session management, and state synchronization between the parent site and the embedded content. For example, an authentication cookie from an SSO provider might be used by the embedded application to verify a user’s identity and grant access to protected resources. When third-party cookies are blocked or deprecated, these mechanisms are disrupted. The embedded application may lose its ability to recognize users, maintain sessions, or synchronize data with the parent site, resulting in degraded functionality or fragmented experiences.

Many embedded applications integrated via iframes depend on third-party cookies for session management. For instance, when a parent portal embeds an application, the embedded content typically uses an SSO cookie stored as a third-party cookie to recognize the user and validate credentials. The iframe acts as a container for displaying the application, while the cookie facilitates seamless authentication and continuity. Without access to these cookies, users may face repeated login prompts, failed access to protected content, or complete application failure, thereby breaking the intended seamless integration.

Session tokens stored in third-party cookies are also used for verifying permissions and maintaining synchronized states across systems. These tokens enable features like personalized settings and consistent behavior between parent sites and embedded applications. Without these tokens, applications may struggle to access user-specific configurations, leading to fragmented or inconsistent interactions. For example, an analytics dashboard embedded within a corporate portal may fail to load personalized data if it cannot retrieve session tokens stored in third-party cookies.

The implications of blocking third-party cookies in iframe embeddings extend beyond authentication. Users may encounter fragmented session management where parent and embedded content operate independently, leading to repeated authentication requests or conflicting session states. Additionally, protected content delivery can fail when embedded applications cannot validate user credentials against a shared authentication context. For instance, a financial reporting tool embedded in a corporate intranet may prompt the user to reauthenticate separately from the portal, even if both systems rely on the same SSO provider. This disrupts the intended seamless experience and introduces unnecessary friction.

To attempt to address these challenges, SameSite cookies offer a potential solution by providing a modern cookie attribute that enhances privacy and security in cross-site interactions. By configuring cookies with the SameSite=None; Secure attribute, websites can explicitly allow cross-site cookie usage while requiring secure transmission over HTTPS. However, the effectiveness of this approach depends on consistent browser support and adherence to SameSite policies. Legacy systems may lack compatibility with this attribute, creating additional barriers.

Token-based authentication mechanisms, such as OAuth, present another alternative. These mechanisms pass short-lived tokens via headers or URL parameters to authenticate users without relying on cookies. Similarly, the window.postMessage API enables secure cross-domain communication, allowing parent sites and embedded applications to exchange authentication and state information directly. While effective in certain contexts, these solutions introduce complexity in implementation and require careful coordination between systems.

Partitioned cookies are an emerging solution designed to address some of the challenges posed by the deprecation of third-party cookies while maintaining privacy protections. Unlike traditional third-party cookies, which are shared across multiple sites that interact with the same third-party domain, partitioned cookies are scoped to the specific first-party context in which they are set. This mechanism allows the same third-party domain to set separate cookies for each first-party site, thereby preventing cross-site tracking while still enabling third-party services to function within individual first-party contexts.

A partitioned cookie differs from traditional cookies in that it includes metadata or flags that define the context in which it is accessible. For example, a partitioned cookie may contain an attribute explicitly identifying the first-party domain with which it is associated. This attribute provides that the cookie is only accessible when the browser is interacting with the specified first-party domain. Additionally, the cookie may include a partitioning flag, which signals to the browser that the cookie is subject to isolation and cannot be accessed outside the specified context. For instance, a browser interacting with two different first-party domains embedding content from the same third-party service would maintain separate instances of the partitioned cookie for each domain. Each instance would contain identical or similar cookie data but would be segregated by its respective first-party association, preventing any cross-site linkage.

The browser enforces these restrictions by leveraging internal mechanisms that map partitioned cookies to the specific first-party context in which they are created. When a request is made to a third-party domain, the browser evaluates the partitioning metadata to determine whether the cookie is accessible. If the request does not originate from the appropriate first-party domain, the cookie is inaccessible, and the request may fail or proceed without the associated session information. This level of granularity enables the browser to maintain robust privacy boundaries while still permitting functional interactions between first-party and third-party domains in well-defined scenarios.

In practical terms, partitioned cookies are stored in isolated “partitions” corresponding to the first-party site a user is visiting. For example, a third-party analytics provider embedded on two different first-party websites could set and access cookies for its domain on each site independently. These cookies would remain distinct and inaccessible across the first-party contexts, ensuring that user behavior on one site cannot be linked to their behavior on another. This separation effectively mitigates privacy concerns associated with traditional third-party cookies by limiting the ability of third-party domains to track users across sites.

Partitioned cookies are particularly useful for addressing use cases that require maintaining session management or authentication in scenarios involving iframes or cross-site fetch requests. For instance, an SSO provider embedded in multiple first-party portals via iframes can use partitioned cookies to manage separate authentication states for each portal. This setup allows the embedded content to function as expected without enabling cross-site tracking. Additionally, applications that embed dynamic content, such as dashboards or data retrieval widgets, can rely on partitioned cookies for maintaining individual session continuity within the specific context of each first-party site.

Despite their benefits, partitioned cookies present several limitations. One significant challenge is that not all browsers currently support this mechanism, and no universal standard mandates its implementation. For instance, SAFARI has introduced similar functionality under Intelligent Tracking Prevention (ITP), but its scope and behavior differ from those of partitioned cookies, creating inconsistencies. This lack of uniformity forces developers to account for multiple cookie-handling models and implement fallback mechanisms for unsupported browsers. Additionally, partitioned cookies may not fully resolve issues related to session continuity for distributed applications that span multiple domains but rely on shared states. In such cases, other technologies, such as token-based authentication or API-based communication, may still be required to bridge the gaps in functionality.

Another potential drawback of partitioned cookies is their impact on performance and complexity. Maintaining separate cookie partitions for each first-party context introduces additional overhead for both browsers and servers. Services interacting with a large number of first-party domains may face increased resource requirements and operational complexity. Furthermore, while partitioned cookies limit cross-site tracking, they may still raise questions about user transparency and consent, as users may not fully understand how their data is being handled in these isolated contexts.

The Storage Access API, a browser feature initially developed by Apple as part of its WebKit engine and later implemented experimentally by other browsers, including Google CHROME, offers an alternative approach to addressing the challenges associated with the deprecation of third-party cookies. This API provides a controlled mechanism—referred to here generically as a “temporary storage access mechanism”—to allow third-party services to regain temporary access to their cookies or other storage resources within specific first-party contexts. Embedded third-party content, such as scripts or iframes, can leverage the API to access storage that would otherwise be restricted under modern browser privacy policies. By scoping access to a single first-party interaction, the storage access API allows third-party services to maintain functionality while adhering to privacy principles that prevent unrestricted cross-site tracking. As used herein, unless the context specifically indicates the specific API of Apple or similar use in CHROME, the term “storage access API” refers to temporary storage access mechanisms that provide the same or equivalent functionality of the Storage Access API of Apple or as used in CHROME.

In operation, the storage access API facilitates requests for storage access through a well-defined process. A third-party service embedded within a first-party context initiates a request for access using the document.requestStorageAccess() method. This request is typically triggered programmatically in response to a user-initiated action in the first party context, such as clicking a button or interacting with embedded content. The browser evaluates the request based on its policies, which may include determining whether the third-party domain previously had storage access in that context or whether user approval is required. If the browser determines that the request satisfies its criteria, it grants temporary access to the requested storage resources.

Upon granting access, the browser confines the scope of storage accessibility to the specific first-party context in which the request was made. For example, a cookie set by a third-party authentication provider can be accessed within the context of an iframe embedded on a parent site, but this access does not extend to other first-party domains embedding the same third-party content. The granted access is inherently transient and is revoked once the user navigates away from the first-party site, the browser session ends, or other conditions defined by the browser’s policy are met.

The storage access API effectively complements partitioned cookies by enabling a “context-specific storage access” functionality. While partitioned cookies enforce isolation at the time of storage, the storage access API allows third-party domains to retain universal storage resources, such as cookies, and dynamically scope their accessibility to specific first-party interactions as needed. For instance, a third-party analytics service embedded in multiple dashboards can use the API to retrieve a universal authentication token for session management within the boundaries of each first-party domain independently.

From a technical perspective, the storage access API introduces additional flexibility to accommodate complex use cases disrupted by the deprecation of third-party cookies. It allows third-party services to maintain global storage resources and to comply with modern privacy standards. By integrating this API, developers can re-enable functionalities such as single sign-on (SSO), session continuity, and personalized user experiences within embedded third-party content.

However, the storage access API also presents limitations. Browser support remains inconsistent, as adoption varies across major browsers. For instance, while SAFARI supports the API as part of its Intelligent Tracking Prevention (ITP) initiative, other browsers like CHROME and FIREFOX offer experimental or partial implementations. This inconsistency can necessitate fallback strategies, increasing the complexity of deployment. Furthermore, scenarios requiring explicit user consent can introduce friction, particularly if users are prompted frequently across different sites. Such repeated prompts may degrade user experience and reduce acceptance rates for granting access.

The temporary and scoped nature of the storage access API imposes additional technical challenges for third-party providers. Systems originally designed for persistent cookies must be adapted to accommodate ephemeral, contextually restricted access. For example, authentication workflows may require modifications to handle repeated requests for storage access, especially in workflows involving multiple first-party domains. This re-engineering effort adds overhead for developers, particularly in environments with diverse browser usage or legacy systems lacking API support.

The present disclosure provides techniques and solutions that can address complications resulting from the deprecation of third-party cookies, or other scenarios where third-party cookies, or their equivalents, are not available. When a user is logged onto a first domain, and wishes to interact with a second domain, a web browser can contact the second domain. In response, the second domain issues both a partitioned cookie and a nonpartitioned cookie. The web browser being used can then select the cookie that is appropriate for its implementation. That is, if the web browser is configured to use partitioned cookies, the web browser will select the partitioned cookie. If the web browser is configured to use the storage access API, the web browser retrieves data from the second domain using the storage access API and the unpartitioned cookie.

In some cases, when a user attempts to access a third-party domain, or the web browser does so based on contents of a particular web page, a user can be prompted to provide authentication information. The cookies can be set in response to user authentication, including when authentication is performed by a separate identity provider. In some cases, the authentication action can be used as an authentication when the storage access API is used. That is, a separate approval is not required for use of the storage access API.

While in some cases both partitioned and unpartitioned cookies are always set, in other cases setting both types of cookies is only performed under certain conditions, and under other conditions only one of a partitioned or an unpartitioned cookie is set. For example, configuration values, reporting tools, or browser settings can be part of a request context, and used to determine the type of cookie that should be used in a particular scenario, and only the appropriate cookie type is set.

### Example 2– Example Use of Partitioned Cookies and Storage Access API

As described in Example 1, while third-party cookies have been used for questionable purposes, they enable many technologies that do not raise ethical concerns, and which are of considerable benefit to users. For example, while termed third-party cookies, they are third party only with respect to a particular domain. An entity, such as a company, may have control over multiple different domains, and it may be beneficial to allow information to be shared across these domains.

As a more specific example, companies may periodically change their domain names, including for marketing type considerations, such as a change in the name of a particular product or service. Some functionality or information for the product or service may be located on the old domain, and other functionality or information located on the new domain. In other cases, a company may have multiple domains through its growth by integrating other companies. For example, a company A with a domain A may acquire a company B with a domain B. In either case, it may be desirable to allow uses to interact with content from a second domain while the user has a “first party” interaction with a first domain.

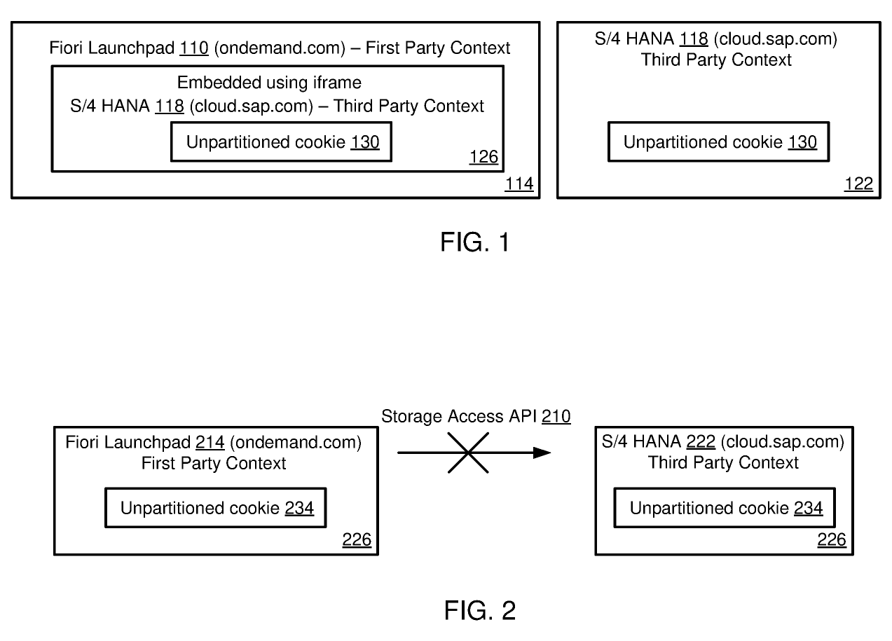

FIG. 1 illustrates a scenario where a user interacts with a first application 110, FIORI LAUNCHPAD of SAP SE, of Walldorf, Germany, hosted on a “first-party” domain 114 of ondemand.com. The Fiori Launchpad application 110 includes embedded content from another application 118, S/4 HANA, also of SAP SE, hosted on a third-party domain 122 of cloud.sap.com. The S/4 HANA application 118 content is embedded within the FIORI LAUNCHPAD application using an iframe 126. To facilitate user interactions, the S/4 HANA application 118 typically sets a cookie 130 for the user’s web browser that is associated with the particular user and used during subsequent interactions with the S/4 HANA domain 122. This cookie enables the FIORI LAUNCHPAD application 110 to retrieve content from the S/4 HANA application 118 via the iframe 130, in seamless operation.

If traditional third-party cookies are unavailable, and the web browser supports partitioned cookies, the scenario in FIG. 1 can still be facilitated. In this case, the S/4 HANA application 118 can set a partitioned cookie scoped to the context of the first-party domain 114, ondemand.com. This allows the cookie to function for interactions initiated through the embedded iframe 126, while still adhering to privacy restrictions by preventing the cookie from being used outside the context of the embedding domain.

FIG. 2 illustrates a scenario similar to that of FIG. 1, but where a storage access API 210 can be used. In this case, the FIORI LAUNCHPAD application 214 on ondemand.com domain 218 remains the first-party domain, while the S/4 HANA application 222 on the cloud.sap.com domain 226 is the third-party domain. Instead of embedding content of the S/4 HANA application 222 using an iframe, the FIORI LAUNCHPAD application 214 interacts with the S/4 HANA application via cross-site fetch requests, using the storage access API 210.

Because an iframe is not used, the third-party domain 226 is not visually or structurally embedded within the first-party site, and as a result, the web browser cannot generate a partitioned cookie scoped to ondemand.com. Instead, the storage access API 210 can be used to provide temporary, scoped access to existing, unpartitioned cookies 234 stored by the cloud.sap.com domain 226 for the duration of the user’s session, facilitating cross-site functionality while adhering to modern privacy standards. The existing unpartitioned cookies 234 for the third-party domain 226 may have been set during a prior interaction where the third-party domain was accessed directly as a first-party domain. Additionally, existing unpartitioned cookies 234 may include those set during earlier third-party interactions prior to the implementation of a cookie policy deprecating traditional third-party cookies.

The scenario of FIG. 2 can have different subscenarios, depending on whether the third-party domain uses an identity provider. In the case of SAP technologies, the use of an identity provider can be IAS (an SAP-specific identity provider), or where IAS is used as a proxy to another identity provider, such as an identity provider that is specific to a particular customer.

In these sub-scenarios, cross-site fetch requests introduce additional challenges when traditional third-party cookies are unavailable, and partitioned cookies cannot be applied due to the lack of an embedding context. In one scenario, S/4 HANA relies on IAS either directly or as a proxy to a customer-specific identity provider (IDP) for user authentication. IAS serves as a centralized identity management system, enabling users to authenticate across SAP applications. However, even if SAP implements a solution such as the storage access API to maintain session continuity, the effectiveness of this approach depends heavily on browser support and the specific capabilities of the customer’s IDP. If the IDP does not support the same mechanisms or requires unpartitioned cookies that are incompatible with modern privacy standards like CHIPS, the authentication flow may fail. This lack of standardization across identity providers, combined with browser-enforced restrictions, complicates the implementation of cross-site functionality, and creates potential gaps in interoperability.

Another challenge arises when the user does not interact directly with S/4 HANA or IAS in the first-party context. Without direct user interaction, browsers typically do not allow APIs like the storage access API to grant temporary access to cookies or storage. This limitation prevents S/4 HANA from leveraging stored session data to authenticate or manage user interactions during cross-site fetch requests. Furthermore, the absence of an embedding context, such as an iframe, means that the browser cannot associate cookies with a specific first-party domain, effectively disabling the use of partitioned cookies in such scenarios. When customer-specific IDPs are involved, these issues become even more pronounced, as such IDPs may not support alternative mechanisms like token-based authentication or may rely on prompts that are not generated by the first-party domain. This combination of browser restrictions, user interaction requirements, and identity provider limitations exacerbates the difficulty of establishing a secure and seamless session in cross-site fetch request scenarios.

### Example 3 – Example Use of Partitioned and Unpartitioned Cookies with Iframes

In one aspect, issues with changes to the handling of third-party cookies, including their deprecation, can be addressed by having what will be the third-party domain in a subsequent interaction set two types of cookies for a web browser, both a partitioned and an unpartitioned cookie.

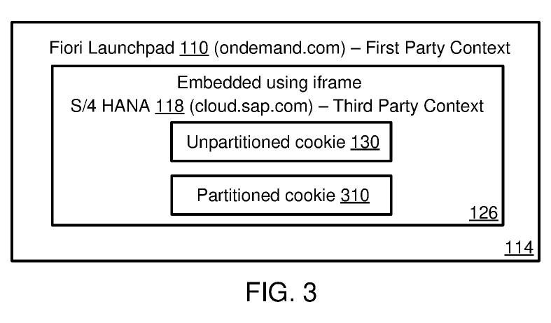

FIG. 3 illustrates the scenario of FIG. 1, updated according to the present disclosure, and where reference numbers from FIG. 1 are maintained in FIG. 3. FIG. 3 differs from FIG. 1, in that a partitioned cookie 310 is set in addition to the unpartitioned cookie 130. The availability of both types of cookies 130, 310 allows third party cookie functionality to be preserved regardless of how a particular browser operates, so that functionality is maintained even if the operation of the browser changes over time. Further, while a web browser may or may not support the storage API, a third-party domain also may or not support the storage API, including authentication mechanisms used by the storage API. Accordingly, the partitioned cookie 310 can be used in scenarios where a web browser supports partitioned cookies and the storage API, but where a third-party domain does not support the storage API.

### Example 4 – Example Use of Partitioned and Unpartitioned Cookies with Storage Access API

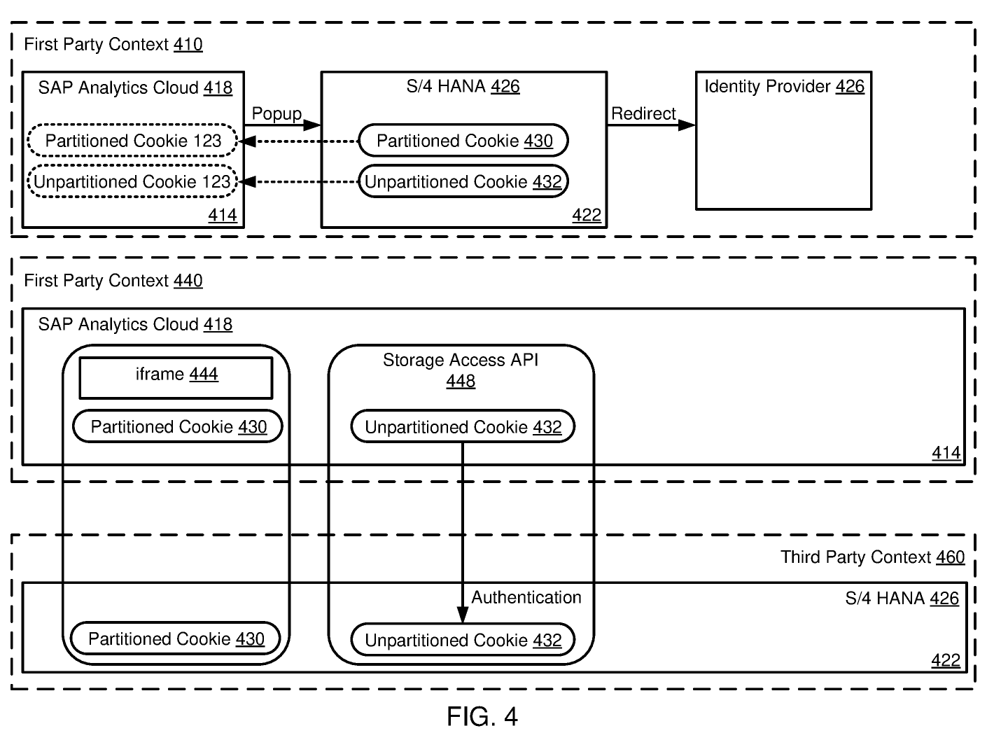

FIG. 4 illustrates how the scenario of FIG. 2, involving the use of the storage API, can be adapted using techniques of the present disclosure involving setting both a partitioned and an unpartitioned cookie.

FIG. 4 illustrates components and operations that are performed in a first-party context 410. A first party domain 414 associated with the SAP ANALYTICS CLOUD application 418 receives a request to access data from the S/4 HANA domain 422. When the request is received, an authentication or authorization action is generated, such as a popup where a user can provide approval, and optionally access credentials, to access data in the S/4 HANA domain. The use of the popup creates a first-party context between the web browser and the S/4 HANA domain 422, allowing the S/4 HANA application 426 to generate or access a partitioned cookie 430 and an unpartitioned cookie 432, which are then stored by the web browser in association with the first-party domain 414 associated with the SAP ANALYTICS CLOUD application 418.

Optionally, the domain that is accessed via a popup from another domain can request external authorization, such as from an identity provider 436. A user can provide authorization information through the popup that is then provided to the identity provider 426. If the identity provider 436 determines that the user is authorized, the S/4 HANA application triggers setting of the partitioned cookie 430 and the unpartitioned cookie 432 in the SAP ANALYTICS CLOUD domain 414.

A first party context 440 represents the first party context 410 after the partitioned cookie 430 and the unpartitioned cookie 432 have been set, after authorization using the popup. A scenario for using the partitioned cookie 430 is similar to that described with respect to FIG. 3. That is, the SAP ANALYTICS CLOUD application 418 includes an iframe 444, which allows the partitioned cookie 430 to be used to access data of the domain 422 for the S/4 HANA application 426. Note that, in this interaction, the domain 422 for the S/4 HANA application 426 is part of a third-party context/domain 460 with respect to the first-party context of the SAP ANALYTICS CLOUD domain 414 and the SAP ANALYTICS CLOUD application 418.

If partitioned cookies 430 are not usable, the storage API 448 can be used to allow the unpartitioned cookie 432 to be used in retrieving data from the S/4 HANA domain 422. As shown, the storage API 448 can also require authorization before it is used, but where authorization does not require a popup providing first-party access to the S/4 HANA domain 422.

### Example 5 – Example Use of Partitioned and Unpartitioned Cookies with Allow-Listed Websites or Domains

Disclosed techniques can be used in contexts in addition to those described above. For example, some browsers may continue to support traditional third-party cookies for websites that are on an “allow list.” This can be similar to the use of the storage API, but without having to formally use the storage API. This can help improve compatibility of domain operations, since a first-party domain does not need to “worry” about whether a third-party domain supports the storage access API and authentication mechanisms. Other than being on the allow list, access to approved third-party domains can be provided without additional authentication operations.

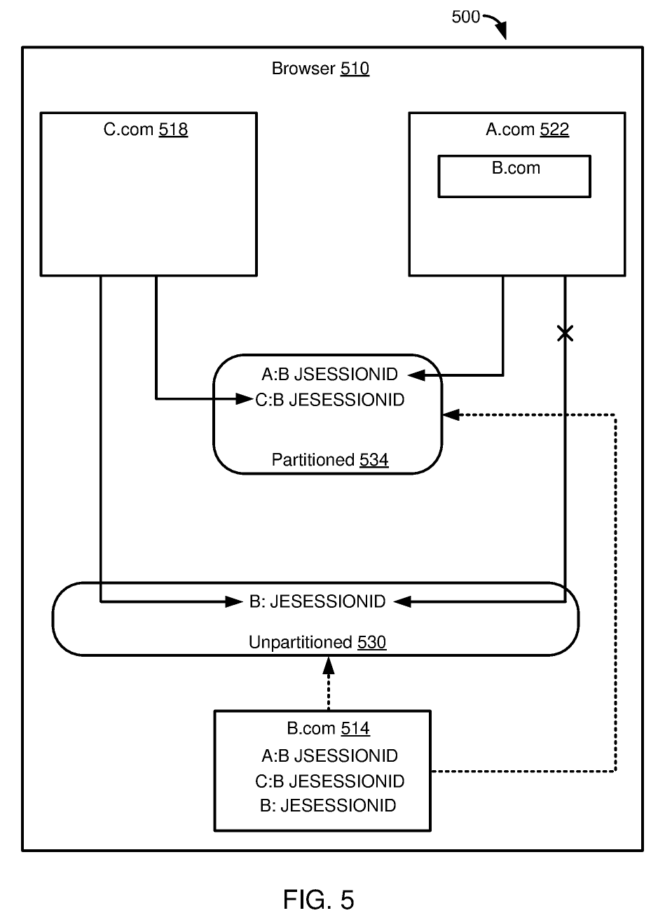

FIG. 5 provides a computing environment 500 illustrating this scenario. In this case, a web browser 510 is configured to have a B.com domain 514 on an allow list when associated with a first-party C.com domain 518, but the B.com domain is not on an allow list for a first party A.com domain 522. The computing environment 500 contains an unpartitioned cookie 530 for the third-party B.com domain 514. Since access to the third-party B.com domain 514 is approved for the C.com first-party domain, the B.com third-party domain can access the unpartitioned cookie 530. The first-party A.com domain 522 cannot access the unpartitioned cookie 530, since it is not a first-party domain approved for accessing the third-party B.com domain 514.

However, if the web browser 510 supports partitioned third-party cookies, the first-party A.com domain 522 can access a partitioned cookie 534 for the third-party B.com domain 514 defined for the A.com domain. In this scenario, the web browser 510 can also access a partitioned cookie 534 of the third-party B.com domain 514 defined for the first-party C.com domain 518.

As with the previously discussed scenarios, having the third-party B.com domain issue both unpartitioned cookies 530 and partitioned cookies 534 allows different web browsers and different first-party domains to still support access to data of third-party contexts.

### Example 6 – Example Switching Between Cookie Setting Modes

While aspects of the present disclosure relate to setting both a partitioned cookie and an unpartitioned cookie for a particular third-party domain, this operation can be configurable. For example, certain entities, users, web browsers, or domains may be known to support particular use scenarios. If a particular access method is known for a particular first-party domain environment, and optionally particular third-party domain environments, the specific type of cookie needed can be deployed rather than deploying both partitioned and unpartitioned cookies.

The determination of whether to set an unpartitioned cookie, a partitioned cookie, or both can be based on several factors, including those associated with a request context. As used herein, “request context” refers to the specific conditions, parameters, and attributes associated with a request to set or retrieve a cookie. This may include identifiers of the web browser, configuration settings for the first or second network domains, user preferences, and other relevant factors that influence the handling and issuance of cookies.

Configuration values for identity providers, such as the SAP IDENTITY AUTHENTICATION SERVICE (IAS), can be checked to see if they support certain authentication mechanisms or cookie handling methods. The type of user authentication method supported by the identity provider, such as SAML or OAuth, can also influence the choice of cookie. Cloud reporting tools can evaluate the usage scenarios of different applications and domains, providing insights into how often certain domains interact and the types of data accessed. These tools can also provide performance metrics, helping to optimize the choice based on real-world data.

Browser settings can also be used in this determination. The system can detect the capabilities of the user’s browser, such as support for partitioned cookies, the storage access API, or legacy third-party cookies. User-configured privacy settings in the browser can also influence the choice, particularly if a user has strict privacy settings that block third-party cookies. Domain-specific policies, such as the presence of allow lists for third-party cookies, can determine whether unpartitioned cookies can be used. If a domain is on the allow list, unpartitioned cookies might be set; otherwise, partitioned cookies would be used. A trust level assigned to different domains can also influence cookie deployment, with higher trust levels potentially allowing for unpartitioned cookies.

User preferences and profiles are factors that can be used in selecting a cookie policy. Individual user preferences regarding privacy and data handling can be taken into account, with users who prefer higher privacy potentially having partitioned cookies set by default. User profiles that include behavior and interaction patterns can help determine the most suitable cookie type, especially for frequent interactions with certain third-party domains. Application-specific needs, such as session management or data access requirements, can dictate the type of cookie needed. Applications needing seamless cross-site data access might benefit from unpartitioned cookies, while those with higher security requirements might prefer partitioned cookies to minimize cross-site tracking risks.

Regulatory compliance is another consideration in selecting a cookie policy. The system can make a selection of cookie type to provide compliance with relevant privacy laws and regulations, such as GDPR or CCPA. This can involve setting partitioned cookies to adhere to stricter privacy standards. By considering these factors, the system can intelligently determine whether to set an unpartitioned cookie, a partitioned cookie, or both, optimizing for compatibility, performance, security, and user preferences.

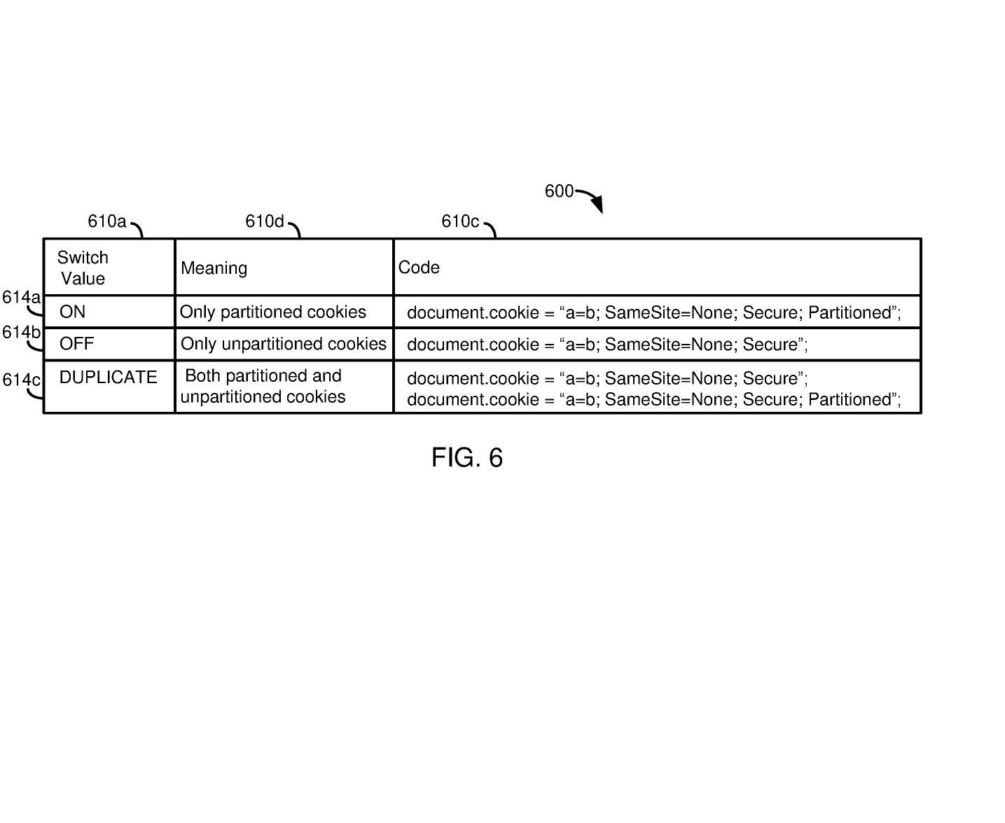

A domain that is expected to be accessed as a third-party domain can be configured with different switch values, which can be set for specific access scenarios. An example of switch values, and corresponding cookies to be provided, is shown in table 600 of FIG. 6. A column 610a provides a switch value, a column 610b provides a meaning of a switch value, and a column 610c provides code for a particular cookie or cookies that will be issued when a specific switch value is present.

In particular, when the switch value is “ON”, in row 614a, only partitioned cookies are issued. When the switch value is “OFF”, as in row 614b, only unpartitioned cookies are issued. When the switch value is “DUPLICATE”, as in row 614c, both partitioned and unpartitioned cookies are issued. Switch values can have a default value. For example, a default value can be “DUPLICATE” which provides that both cookies are available when a particular type of access available for a given scenario is not known, or is not known to be stable.

In one implementation, the disclosed cookie technique is integrated within the SAP ABAP APPLICATION SERVER. However, the technology can be used with other types of servers, including other application servers. This involves duplicating cookies during the construction of the HTTP response object. When a request is processed by the ABAP server, the server constructs an HTTP response that includes the necessary cookies. To implement the disclosed techniques, the server is configured to duplicate each cookie, creating both a partitioned and an unpartitioned version.

This duplication can be controlled by various profile parameters. One parameter enables the duplication process, with the default behavior being to not change any cookies to maintain backward compatibility. A parameter can be used to restrict the cookie duplication to HTTP requests with certain “User-Agent” headers, ensuring that only affected browsers based on Chromium are targeted. The default regular expression for these headers is “Chrom(ium)/((11[4-9])|(1[2-9][0-9])|([2-9][0-9]))”. More generally, the first parameter can be used to indicate user-agent headers for which duplication will be performed. Another parameter defines an exclude list, which can also be defined as a regular expression. If the user-agent matches the “exclude” parameter, cookie duplication is not performed. Two additional parameters can be used to restrict cookie duplication to certain cookie names, allowing for fine-grained control over which cookies are duplicated. These parameters can be implemented in a similar manger to the user-agent parameters, where one parameter defines, such as through a regular expression, cookie names for which cookie duplication is to be performed, and another parameter defines, such as through a regular expression, cookie names for which cookie duplication is not performed.

In another implementation, the disclosed cookie technique is integrated within the SAP WEB DISPATCHER, or another intermediary between a server and a client. The Web Dispatcher acts as an intermediary (such as a web proxy), handling HTTP requests and responses between clients and the backend servers. When an HTTP response passes through the WEB DISPATCHER, the response is re-written to include duplicated cookies. Similar to the ABAP server implementation, the WEB DISPATCHER is configured to duplicate each cookie, creating both a partitioned and an unpartitioned version. This duplication can also be controlled using the parameters discussed above.

The SAP WEB DISPATCHER is particularly advantageous for entities that have on-premises application servers, as opposed to cloud-hosted servers managed by a service provider. The SAP WEB DISPATCHER allows an entity to implement the cookie technique on behalf of a server without requiring modifications to the client’s web application software, which they might be reluctant to do. This approach provides a seamless way to integrate the cookie technique without disrupting existing applications or requiring significant changes to the client’s infrastructure.

In terms of specific use cases, the ABAP server implementation is typically involved directly in processing browser requests and generating HTTP responses that include the necessary cookies. This is suitable for scenarios where the backend server has direct control over the cookie management process. For example, when a browser requests access to a first-party domain that interacts with a third-party domain, the ABAP server can provide that both partitioned and unpartitioned cookies are set appropriately in the HTTP response. For example, when a browser requests access to a first-party domain that interacts with a third-party domain, the ABAP server can ensure that both partitioned and unpartitioned cookies are set appropriately in the HTTP response.

The SAP Web Dispatcher, on the other hand, is used as an intermediary between the browser and the backend servers. It is particularly useful in scenarios where the backend server might not have direct control over the cookie management process or where modifications to the backend server are not feasible. By re-writing HTTP responses to include duplicated cookies, the Web Dispatcher can manage cookie settings on behalf of the backend servers. This is especially beneficial for on-premises customers who need to implement the cookie technique without altering their existing web application software.

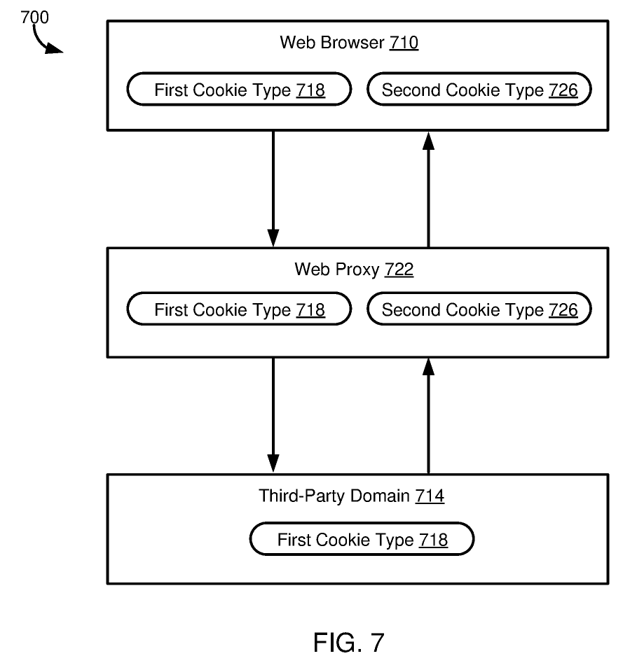

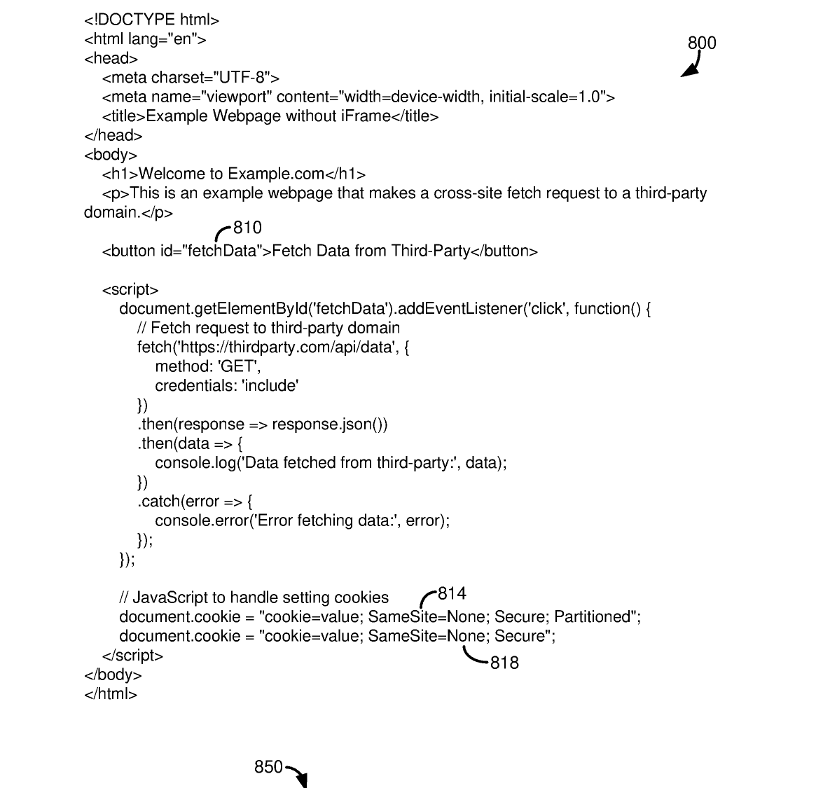

FIG. 7 illustrates a computing environment 700 that uses a web proxy, such as the SAP WEB DISPATCHER. A web browser 710 accesses a third-party domain 714, either in a third-party context or in a first-party context. The third-party domain 714 issues a first cookie type 718. A message with the first cookie type is sent to a web proxy 722 to be forwarded to the web browser 710. The web proxy 722 generates a second cookie type 726. The web proxy 710 sends the first cookie type 718 and the second cookie type 726 to the web browser 710.

### Example 7 – Example Code Setting Partitioned and Unpartitioned Cookies

FIG. 8 provides example code that can be used to implement disclosed techniques. In particular, code 800 illustrates a definition 810 of a user interface element that results in a cross-site fetch request, to a third-party domain. The response from the third-party domain includes values for a partitioned cookie and an unpartitioned cookie, which are set using code lines 814, 818.

Code 850 of FIG. 8 illustrates an alternative approach, where cookies are set via an HTTP response from the third-party domain, such as by the ABAP server discussed in Example 8, or a Web Dispatcher that rewrites HTTP responses from the third-party domain. In this case, the web browser processes the response and sets the cookies for the appropriate first-party domain.

### Example 8 – Example Operations

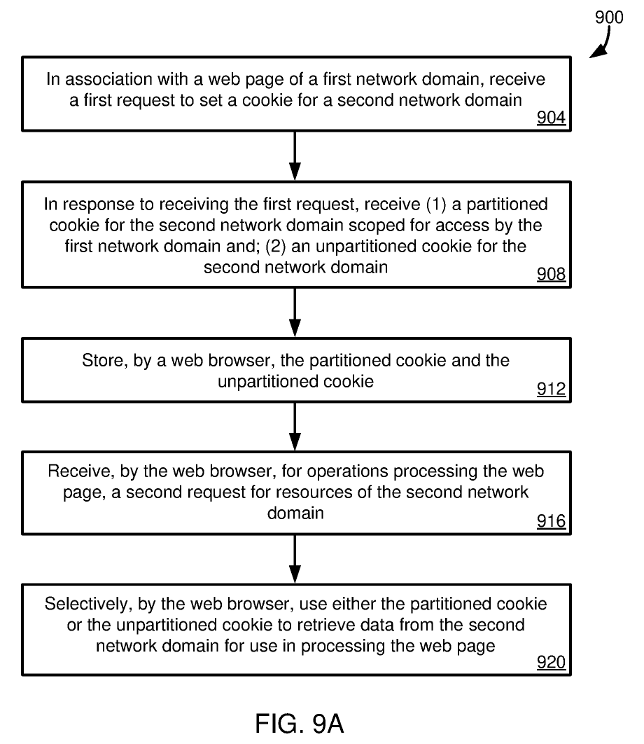

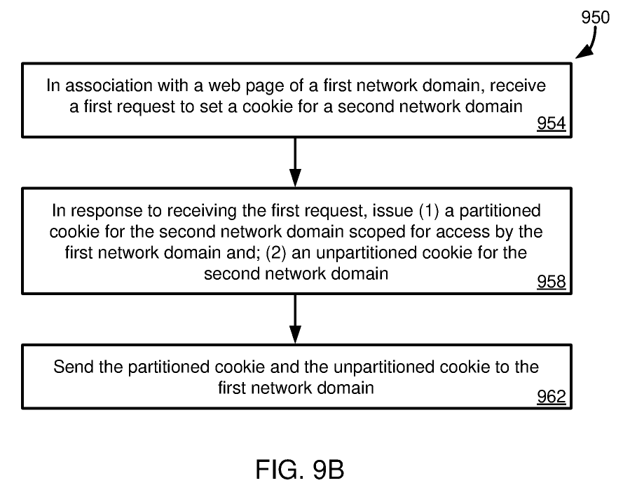

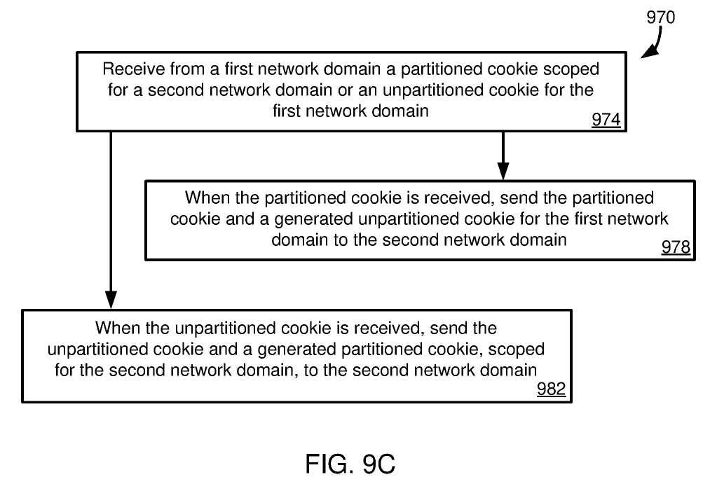

FIG. 9A is a flowchart of a process 900 of managing cookies in a computing system that includes a web browser. At 904, in association with a web page of a first network domain, a first request to set a cookie for a second network domain is received. At 908, in response to receiving the first request, a partitioned cookie for the second network domain scoped for access by the first network domain and an unpartitioned cookie for the second network domain are received. At 912, the partitioned cookie and the unpartitioned cookie are stored by a web browser. At 916, for operations processing the web page, a second request for resources of the second network domain is received by the web browser. At 920, the web browser selectively uses either the partitioned cookie or the unpartitioned cookie to retrieve data from the second network domain for use in processing the web page.

FIG. 9B is a flowchart of a process 950 of issuing and sending cookies to a web browser of a first network domain. At 954, in association with a web page of a first network domain, a first request to set a cookie for a second network domain is received. At 958, in response to receiving the first request, a partitioned cookie for the second network domain scoped for access by the first network domain and an unpartitioned cookie for the second network domain are issued. At 962, the partitioned cookie and the unpartitioned cookie are sent to the first network domain.

FIG. 9C is a flowchart of a process 970 of handling cookies in a computing system that mediates communications between a first network domain and a second network domain. At 974, a partitioned cookie scoped for a second network domain or an unpartitioned cookie for the first network domain is received from a first network domain. At 978, when the partitioned cookie is received, the partitioned cookie and a generated unpartitioned cookie for the first network domain are sent to the second network domain. At 982, when the unpartitioned cookie is received, the unpartitioned cookie and a generated partitioned cookie, scoped for the second network domain, are sent to the second network domain.

### Example 9 – Additional Examples

Example 1 is a computing system that includes at least one hardware processor, at least one memory coupled to the at least one hardware processor, and one or more computer-readable storage media storing computer-executable instructions. When executed, these instructions cause the computing system to perform operations. The operations include, in association with a web page of a first network domain, receiving a first request to set a cookie for a second network domain. In response to receiving the first request, a partitioned cookie for the second network domain scoped for access by the first network domain and an unpartitioned cookie for the second network domain are received. The partitioned cookie and the unpartitioned cookie are stored by a web browser. For operations processing the web page, a second request for resources of the second network domain is received by the web browser. The web browser selectively uses either the partitioned cookie or the unpartitioned cookie to retrieve data from the second network domain for use in processing the web page.

Example 2 is the computing system of Example 1, where the selectively retrieving uses the unpartitioned cookie. The operations further include, prior to retrieving data from the second network domain in response to the second request, rendering a user interface element that includes content requesting approval to retrieve data from the second network domain using the unpartitioned cookie. User input approving retrieval from the second network domain is received through the user interface. In response to the user input, an access control providing temporary access to the unpartitioned cookie for use with the first network domain is invoked.

Example 3 is the computing system of Example 1 or Example 2, the operations further including, in response to receiving the first request, determining a cookie issuance policy specified for a request context of the first request. It is determined that the request context results in issuing both a partitioned cookie and an unpartitioned cookie, where the receiving of the partitioned cookie and the unpartitioned cookie is performed in response to the determining.

Example 4 is the computing system of Example 3, where the request context includes an identifier of a web browser.

Example 5 is the computing system of Example 3 or Example 4, where the request context includes a configuration setting for the first network domain.

Example 6 is the computing system of any of Examples 3-5, where the request context includes a configuration setting for the second network domain.

Example 7 is the computing system of any of Example 3-6, where the request context includes a cookie issuance configuration setting of the second network domain.

Example 8 is the computing system of any of Examples 1-7, the operations further including, in response to the first request, by the web browser, within the web page, accessing the second network domain in a first-party context, where the unpartitioned cookie is stored while the second network domain is accessed in a first-party context.

Example 9 is the computing system of any of Examples 1-8, the operations further including, receiving a third request to set a cookie for a third network domain. A cookie issuance policy specified for a request context of the third request is determined. Based on the cookie issuance policy, either a partitioned cookie for the third network domain scoped to the first network domain, an unpartitioned cookie for the third network domain, or both a partitioned cookie for the third network domain scoped to the first network domain and an unpartitioned cookie for the third network domain are received.

Example 10 is a method, implemented in a computing system that includes at least one hardware processor and at least one memory coupled to the at least one hardware processor. The method includes, in association with a web page of a first network domain, receiving a first request to set a cookie for a second network domain. In response to receiving the first request, a partitioned cookie for the second network domain scoped for access by the first network domain and an unpartitioned cookie for the second network domain are issued. The partitioned cookie and the unpartitioned cookie are sent to the first network domain.

Example 11 is the method of Example 10, further including, in response to receiving the first request, determining a cookie issuance policy specified for a request context of the first request . It is determined that the request context results in issuing both a partitioned cookie and an unpartitioned cookie, where the issuing of the partitioned cookie and the unpartitioned cookie is performed in response to the determining.

Example 12 is the method of Example 11, where the request context includes an identifier of a web browser.

Example 13 is the method of Example 11 or Example 12, where the request context includes a configuration setting for the first network domain.

Example 14 is the method of any of Examples 11-13, where the request context includes a configuration setting for the second network domain.

Example 15 is the method of Example 10, further including, receiving a third request to set a cookie for a third network domain. A cookie issuance policy specified for a request context of the third request is determined. Based on the cookie issuance policy, either a partitioned cookie for the third network domain scoped to the first network domain, an unpartitioned cookie for the third network domain, or both a partitioned cookie for the third network domain scoped to the first network domain and an unpartitioned cookie for the third network domain are sent.

Example 16 is one or more non-transitory computer-readable storage media including computer-executable instructions that, when executed by a computing system comprising at least one hardware processor and at least one memory coupled to the at least one hardware processor, cause the computing system to receive from a first network domain a partitioned cookie scoped for a second network domain or an unpartitioned cookie for the first network domain. The computer-executable instructions, when executed by the computing system, cause the computing system to either (1) when the partitioned cookie is received, send the partitioned cookie and a generated unpartitioned cookie for the first network domain to the second network domain; or (2) when the unpartitioned cookie is received, send the unpartitioned cookie and a generated partitioned cookie, scoped for the second network domain, to the second network domain.

Example 17 is the one or more non-transitory computer-readable storage media of Example 16, further including computer-executable instructions that, when executed by the computing system, cause the computing system to, in response to receiving the partitioned cookie or the unpartitioned cookie, determine a cookie issuance policy associated with a request context of the partitioned cookie or the unpartitioned cookie. The computer-executable instructions, when executed by the computing system, cause the computing system to determine that the request context results in issuing both a partitioned cookie and an unpartitioned cookie, where the sending of cookies under (1) or (2) is performed in response to the determining.

Example 18 is the one or more non-transitory computer-readable storage media of Example 17, where the request context includes an identifier of a web browser.

Example 19 is the one or more non-transitory computer-readable storage media of Example 17 or Example 18, where the request context includes a configuration setting for the first network domain.

Example 20 is the one or more non-transitory computer-readable storage media of any of Examples 17-19, where the request context includes a configuration setting for the second network domain.

### Example 10 – Computing Systems

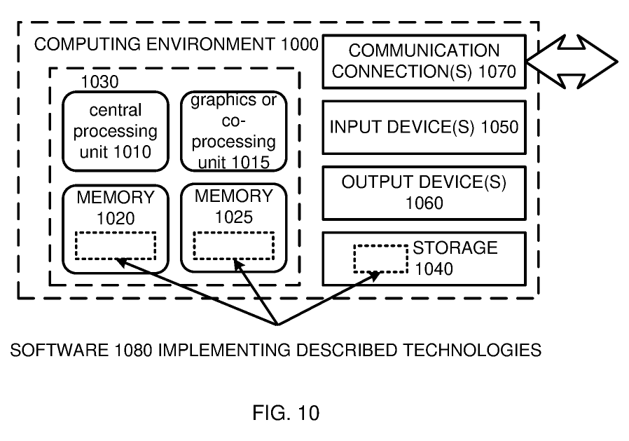

FIG. 10 depicts a generalized example of a suitable computing system 1000 in which the described innovations may be implemented. The computing system 1000 is not intended to suggest any limitation as to scope of use or functionality of the present disclosure, as the innovations may be implemented in diverse general-purpose or special-purpose computing systems.

With reference to FIG. 10, the computing system 1000 includes one or more processing units 1010, 1015 and memory 1020, 1025. In FIG. 10, this basic configuration 1030 is included within a dashed line. The processing units 1010, 1015 execute computer-executable instructions, such as for implementing the features described in Examples 1-9. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 10 shows a central processing unit 1010 as well as a graphics processing unit or co-processing unit 1015. The tangible memory 1020, 1025 may be volatile memory (e.g., registers, cache, RAM), non-volatile memory (e.g., ROM, EEPROM, flash memory, etc.), or some combination of the two, accessible by the processing unit(s) 1010, 1015. The memory 1020, 1025 stores software 1080 implementing one or more innovations described herein, in the form of computer-executable instructions suitable for execution by the processing unit(s) 1010, 1015.

A computing system 1000 may have additional features. For example, the computing system 1000 includes storage 1040, one or more input devices 1050, one or more output devices 1060, and one or more communication connections 1070, including input devices, output devices, and communication connections for interacting with a user. An interconnection mechanism (not shown) such as a bus, controller, or network interconnects the components of the computing system 1000. Typically, operating system software (not shown) provides an operating environment for other software executing in the computing system 1000, and coordinates activities of the components of the computing system 1000.

The tangible storage 1040 may be removable or non-removable, and includes magnetic disks, magnetic tapes or cassettes, CD-ROMs, DVDs, or any other medium which can be used to store information in a non-transitory way and which can be accessed within the computing system 1000. The storage 1040 stores instructions for the software 1080 implementing one or more innovations described herein.

The input device(s) 1050 may be a touch input device such as a keyboard, mouse, pen, or trackball, a voice input device, a scanning device, or another device that provides input to the computing system 1000. The output device(s) 1060 may be a display, printer, speaker, CD-writer, or another device that provides output from the computing system 1000.

The communication connection(s) 1070 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules or components include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

In various examples described herein, a module (e.g., component or engine) can be “coded” to perform certain operations or provide certain functionality, indicating that computer-executable instructions for the module can be executed to perform such operations, cause such operations to be performed, or to otherwise provide such functionality. Although functionality described with respect to a software component, module, or engine can be carried out as a discrete software unit (e.g., program, function, class method), it need not be implemented as a discrete unit. That is, the functionality can be incorporated into a larger or more general-purpose program, such as one or more lines of code in a larger or general-purpose program.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 11 – Cloud Computing Environment

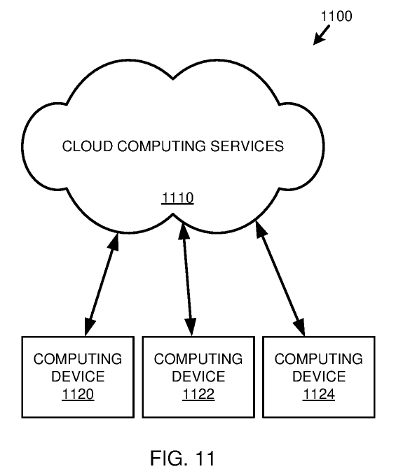

FIG. 11 depicts an example cloud computing environment 1100 in which the described technologies can be implemented. The cloud computing environment 1100 comprises cloud computing services 1110. The cloud computing services 1110 can comprise various types of cloud computing resources, such as computer servers, data storage repositories, networking resources, etc. The cloud computing services 1110 can be centrally located (e.g., provided by a data center of a business or organization) or distributed (e.g., provided by various computing resources located at different locations, such as different data centers and/or located in different cities or countries).

The cloud computing services 1110 are utilized by various types of computing devices (e.g., client computing devices), such as computing devices 1120, 1122, and 1124. For example, the computing devices (e.g., 1120, 1122, and 1124) can be computers (e.g., desktop or laptop computers), mobile devices (e.g., tablet computers or smart phones), or other types of computing devices. For example, the computing devices (e.g., 1120, 1122, and 1124) can utilize the cloud computing services 1110 to perform computing operations (e.g., data processing, data storage, and the like).

### Example 12 – Implementations

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 10, computer-readable storage media include memory 1020 and 1025, and storage 1040. The term computer-readable storage media does not include signals and carrier waves. In addition, the term computer-readable storage media does not include communication connections (e.g., 1070).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network, or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Python, Ruby, ABAP, SQL, Adobe Flash, or any other suitable programming language, or, in some examples, markup languages such as html or XML, or combinations of suitable programming languages and markup languages. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present, or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computing system comprising:
at least one hardware processor;
at least one memory coupled to the at least one hardware processor;
one or more computer-readable storage media storing computer-executable instructions that, when executed, cause the computing system to perform operations comprising:
in association with a web page of a first network domain, receiving a first request to set a cookie for a second network domain;
in response to receiving the first request, receiving (1) a partitioned cookie for the second network domain scoped for access by the first network domain and; (2) an unpartitioned cookie for the second network domain;
storing, by a web browser, the partitioned cookie and the unpartitioned cookie;
receiving, by the web browser, for operations processing the web page, a second request for resources of the second network domain; and
selectively, by the web browser, using either the partitioned cookie or the unpartitioned cookie to retrieve data from the second network domain for use in processing the web page.

2. The computing system of claim 1, wherein the selectively retrieving uses the unpartitioned cookie, the operations further comprising:
prior to retrieving data from the second network domain in response to the second request, rendering a user interface element that comprises content requesting approval to retrieve data from the second network domain using the unpartitioned cookie;
receiving through the user interface user input approving retrieval from the second network domain; and
in response to the user input, invoking an access control providing temporary access to the unpartitioned cookie for use with the first network domain.

3. The computing system of claim 1, the operations further comprising:
in response to receiving the first request, determining a cookie issuance policy specified for a request context of the first request; and
determining that the request context results in issuing both a partitioned cookie and an unpartitioned cookie, wherein the receiving the partitioned cookie and the unpartitioned cookie is performed in response to the determining.

4. The computing system of claim 3, wherein the request context comprises an identifier of a web browser.

5. The computing system of claim 3, wherein the request context comprises a configuration setting for the first network domain.

6. The computing system of claim 3, wherein the request context comprises a configuration setting for the second network domain.

7. The computing system of claim 3, wherein the request context comprises a cookie issuance configuration setting of the second network domain.

8. The computing system of claim 1, the operations further comprising:
in response to the first request, by the web browser, within the web page, accessing the second network domain in a first-party context, wherein the unpartitioned cookie is stored while the second network domain is accessed in a first-party context.

9. The computing system of claim 1, the operations further comprising:
receiving a third request to set a cookie for a third network domain;
determining a cookie issuance policy specified for a request context of the third request; and
based on the cookie issuance policy, receiving either (1) a partitioned cookie for the third network domain scoped to the first network domain, (2) an unpartitioned cookie for the third network domain, or (3) both a partitioned cookie for the third network domain scoped to the first network domain and an unpartitioned cookie for the third network domain.

10. A method, implemented in a computing system comprising at least one hardware processor and at least one memory coupled to the at least one hardware processor, the method comprising:
in association with a web page of a first network domain, receiving a first request to set a cookie for a second network domain;
in response to receiving the first request, issuing (1) a partitioned cookie for the second network domain scoped for access by the first network domain and; (2) an unpartitioned cookie for the second network domain; and
sending the partitioned cookie and the unpartitioned cookie to the first network domain.

11. The method of claim 10, further comprising:
in response to receiving the first request, determining a cookie issuance policy specified for a request context of the first request; and
determining that the request context results in issuing both a partitioned cookie and an unpartitioned cookie, wherein the issuing the partitioned cookie and the unpartitioned cookie is performed in response to the determining.

12. The method of claim 11, wherein the request context comprises an identifier of a web browser.

13. The method of claim 11, wherein the request context comprises a configuration setting for the first network domain.

14. The method of claim 11, wherein the request context comprises a configuration setting for the second network domain .

15. The method of claim 1, further comprising:
receiving a third request to set a cookie for a third network domain;
determining a cookie issuance policy specified for a request context of the third request; and
based on the cookie issuance policy, sending either (1) a partitioned cookie for the third network domain scoped to the first network domain, (2) an unpartitioned cookie for the third network domain, or (3) both a partitioned cookie for the third network domain scoped to the first network domain and an unpartitioned cookie for the third network domain.

16. One or more non-transitory computer-readable storage media comprising:
computer-executable instructions that, when executed by a computing system comprising at least one hardware processor and at least one memory coupled to the at least one hardware processor, cause the computing system to receive from a first network domain a partitioned cookie scoped for a second network domain or an unpartitioned cookie for the first network domain; and
computer-executable instructions that, when executed by the computing system, cause the computing system to either (1) when the partitioned cookie is received, send the partitioned cookie and a generated unpartitioned cookie for the first network domain to the second network domain; or (2) when the unpartitioned cookie is received, send the unpartitioned cookie and a generated partitioned cookie, scoped for the second network domain, to the second network domain.

17. The one or more non-transitory computer-readable storage media of claim 10, further comprising:
computer-executable instructions that, when executed by the computing system, cause the computing system to, in response to receiving the partitioned cookie or the unpartitioned cookie, determine a cookie issuance policy associated with a request context of the partitioned cookie or the unpartitioned cookie; and
computer-executable instructions that, when executed by the computing system, cause the computing system to determine that the request context results in issuing both a partitioned cookie and an unpartitioned cookie, wherein the sending of cookies under (1) or (2) is performed in response to the determining.

18. The one or more non-transitory computer-readable storage media of claim 17, wherein the request context comprises an identifier of a web browser.

19. The one or more non-transitory computer-readable storage media of claim 17, wherein the request context comprises a configuration setting for the first network domain.

20. The one or more non-transitory computer-readable storage media of claim 17, wherein the request context comprises a configuration setting for the second network domain.
